(19) United States
(12) Patent Application Publication
(10) Pub. No.: US 2014/0198180 A1
(43) Pub. Date: Jul. 17, 2014

(54) DATA COMMUNICATION BETWEEN NON-HOMOGENEOUS DISPLAY CLIENTS AND DATA SERVERS AND RELATED METHODS

(71) Applicant: 3DMedia Corporation, Durham, NC (US)

(72) Inventors: Tassos Markas, Chapel Hill, NC (US); Bahram Dahi, Chapel Hill, NC (US)

(21) Appl. No.: 14/154,473

(22) Filed: Jan. 14, 2014

Related U.S. Application Data
(60) Provisional application No. 61/751,979, filed on Jan. 14, 2013.

(51) Int. Cl. H04N 13/00

(52) U.S. Cl. CPC H04N 13/0029
USPC 348/43

(57) ABSTRACT

Data communication between non-homogeneous display clients and data servers and related methods are disclosed. According to an aspect, an example method may use one or more processors and memory for receiving data from a storage device. The method may also include changing at least one parameter of the data to match at least one characteristics of a target display device. Further, the method may include sending the manipulated data to the target display device via a network.

### CROSS REFERENCE TO RELATED APPLICATION

This application claims the benefit of U.S. Provisional Patent Application Ser. No. 61/751,979, filed Jan. 14, 2013, the disclosure of which is incorporated herein by reference in its entirety.

### TECHNICAL FIELD

The presently disclosed subject matter relates to display devices that may be referred to as clients and servers that prepare multimedia content for the display devices. More particularly, the presently disclosed subject matter relates to data communication between non-homogeneous display clients and data servers.

### BACKGROUND

The consumer market has been saturated with a multitude of display devices that are connected through wireless or wireline networks. Those devices vary in operating systems, functionality, as well as size and characteristics of the display screens. Examples of those devices include cellphones, tablets, smart televisions (TVs), personal computers (PCs), monitors, projectors, and in general any device that is connected to the Internet and has some display capability to display data, images, and video. Each display device, referred also as display client, can have different display capabilities. For example, smartphones and tablets have in general smaller displays with smaller resolution. Smart TVs and projectors can typically display higher resolution images and video. In addition, display clients have the ability to display different imaging formats such as standard and high definition, three-dimensional (3D), ultra-high resolution (i.e., 4K and 8K formats) images and video. In addition, 3D displays can use active, passive, or glass-free display technology. In the latter case, multiple views of the same scene need to be transmitted to properly display the imagery data. Furthermore, some of the display clients can be open or closed. In closed systems, third-party developers cannot develop and offer new applications without the involvement of the manufacturers. In those cases, typically third party applications are compiled and included with the main software distribution of the display device. In open systems (i.e., smartphones, Smart TVs, etc.), third-party applications can be directly offered to the consumers and consumers can download and run those applications on their devices. All those display clients create a non-homogenous device cluster, where each type of device needs to receive different types of data to operate.

Data servers are large databases containing various types of data including, but not limited to, imagery information such as photos and videos. The imagery data can be user generated or supplied by studios, broadcasters, consumers, and in general any content creator. Data servers may constitute social networking sites such as the FACEBOOK® social networking service, the YOUTUBE® video sharing server, photo sharing sites operated by camera makers, or other social networking sites. Those data servers may run different operating systems and may have different application procedural interfaces (APIs) used to communicate with them.

In such environments, typically web-browsers perform the connectivity and translation servers and clients. Web browsers have a set of languages that communicate with severs to get data and perform services. Applications run on display clients send commands to servers, receive the appropriate data, and format the data for their displays. However, embedded devices cannot use effectively web browsers to perform this functionality due to display sizes, limitation on user interface (i.e., no keyboards), and limited computational resources. In this case, it is common to develop applications on the display clients that communicate directly to the data servers. However, because of the non-homogenous nature of display clients and data servers, presentation of content, whether it is data, images, video, 3D, or the like on the display clients becomes a very inefficient process since each display client needs to have a separate application to communicate with a corresponding process on the server that will prepare content for the target device. The development and offering of various applications on the display clients becomes an even more severe problem since those applications need to be developed for each server. Efficient communication can be accomplished if servers know the capabilities of the display devices. For example, a server may want to send a low-resolution image on a cellphone but a high-resolution image on a TV to optimize communication. Bandwidth capability between the servers and the clients may also control quality of service for the transmitted information. Finally, in cases of transmission of 3D content, the servers may need to adjust depth parameters for transmitted content taking in consideration the size of the 3D display as well as its type. Although the discussion if focused on imagery types of data, the embodiments of the present disclosure can be applied to any other non-imagery type of data that is to be presented in any display client.

In view of the foregoing, it is desired to provide improved techniques and systems related to display devices, display clients, and data servers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are techniques, systems, and methods of data communication between non-homogeneous display clients and data servers. Particularly, for example, the subject matter disclosed herein provides methods that enable non-homogenous display client to communicate with non-homogenous data servers through the use of intermediate smart gateways that perform the function of translating requests, sent by the display clients, to requests that the data servers can understand, and the data servers responding with the proper responses to the display clients. The function of the smart gateways can be to leave the functionality of the data servers as much intact as possible. The smart gateways can perform the main load of translating the requests between the display clients and the data servers as well as manipulating the data in way that it is optimally presented to the display clients.

Disclosed herein is a smart gateway that can receive requests from display clients, translate those requests to something that data servers can understand, send those requests to the data servers, receive the responses from servers, possibly customize the imagery information to meet the requirement and characteristics of the display clients, and finally send them to the display clients. All those operations are to be executed in a transparent manner without any user intervention. The smart gateway has knowledge of the display clients as well as the data servers and can perform the translation operations in a transparent manner. The smart gateway can be implemented in the cloud or can be integrated as functionality within the data servers. In the latter case, it acts as a gateway between multiple display clients and a single data server. A cluster of smart gateways can be also employed to implement the presented functionality. The cluster may contain homogenous gateways that simple share the communication load, or it can contain non-homogenous gateways that serve specific servers and specific display clients. The smart gateway can be implemented in software, in hardware, or in a combination of both. Hardware implementation can have the form of a system including different integrated circuits connected together, integrated circuits, or a combination thereof. The smart gateways can also support additional functionalities such as background music, advertising, content sharing, services such as photo-printing, as well as any other functionality that enhances user experience while viewing the presented content.

According to an aspect, a method may use one or more processors and memory for receiving data from a storage device. The method may also include changing at least one parameter of the data to match at least one characteristics of a target display device. Further, the method may include sending the manipulated data to the target display device via a network.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is an exemplary diagram of an environment or system in which a smart gateway can be deployed in accordance with embodiments of the present disclosure;

FIG. 2 is an exemplary diagram of a smart gateway architecture in accordance with embodiments of the present disclosure;

FIG. 3 is an exemplary block level diagram of a simplified communication between a client and a server in accordance with embodiments of the present disclosure;

FIG. 4 is an exemplary block level diagram of an advanced communication between a client and a server in accordance with embodiments of the present disclosure; and

FIG. 5 is a flowchart of an example method for managing data communications with a target display device in accordance with embodiment of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

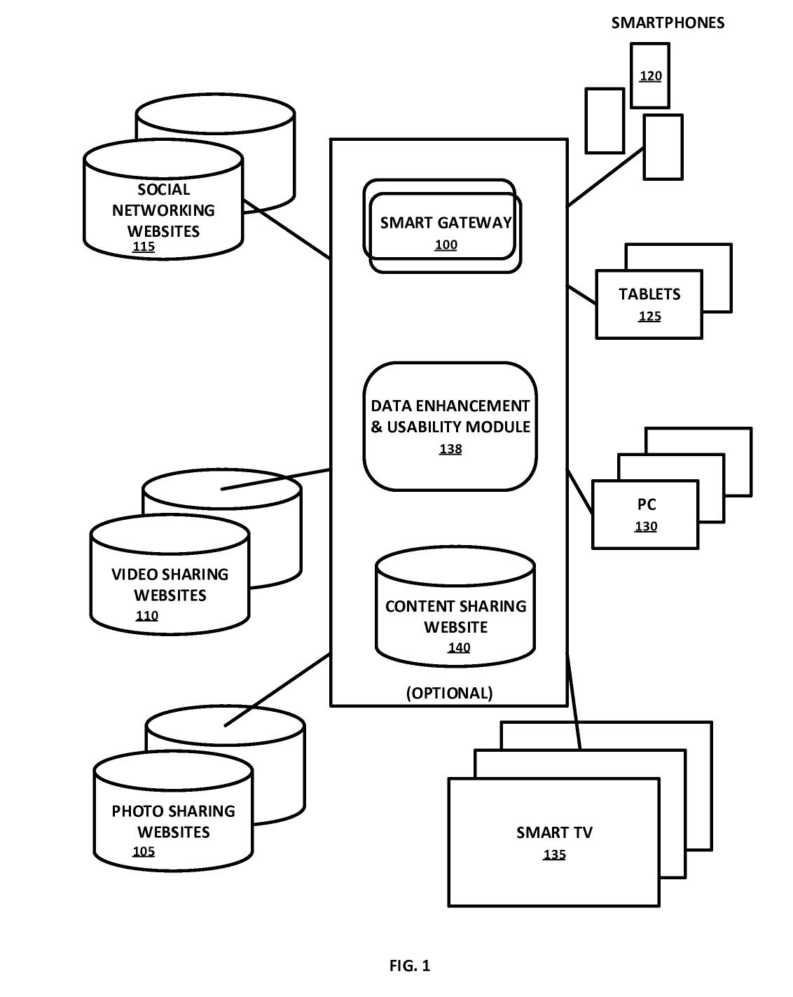

FIG. 1 illustrates a block diagram of an environment or system in which an example cluster of smart gateways 100 can be deployed to efficiently communicate imagery information according to embodiments of the present disclosure. The smart gateway can connect databases or websites, referred to as servers, containing data which may include video and/or images to display clients. Servers can include social networking databases 115, video sharing websites 110, photo sharing websites 105, and the like. Examples of display clients are smartphones 120, tablets 125, PCs and laptops 130, smart TVs and projectors 135, and the like. The function of the smart gateway 100 is to seamlessly pass data such as video and images from the servers to clients and customize the imagery information to meet the display characteristics of the display clients. Such customization may involve resizing the imagery information to match the resolution of the display devices, customize the color parameters to match the gamma of the display, transcode a video stream from one format to another format that is understandable by the client, changing the format of three-dimensional data to meet the format of a three-dimensional display device, generating multiple three dimensional views to match characteristics of auto-stereoscopic displays, changing the parallax or other three-dimensional parameters to match the characteristics of the three-dimensional display or the three-dimensional preferences of a user, or its distance from the screen, provided such information can be available back to the smart gateway 100, or in general any operation that manipulates data residing on servers to match one or more characteristics of the display clients.

In addition, the smart gateways 100 can interject data and other pieces of information to imagery data before they send it back to the clients using a data enhancement and data usability module 138. Such information may include additional information on the supplied data, such as location the captured imagery data, device information that was used to capture the data, suggestions on similar content of selected data, addition of music to enhance user experience, as well as advertising content that gets transmitted with the imagery data. All this information may be enabled or disabled by the application that is running on the client and/or the user.

The smart gateway cluster can utilize one or more smart gateways 100 that can reside on the same or different geographical places to serve different requests based on load, geographic location of severs or clients, types of services performed, types of servers or clients they serve, and the like. The smart gateways 100 can also utilize one or more computers, processor boards, or processors. Finally, the smart gateway cluster can contain its own content database 140 from where it can supply images, video, or other types of data to clients. In this case, the smart gateway cluster acts also as a server.

Typically, web browsers or applications that run on clients may implement all the work of translating the data contained in servers to a format that clients understand and in some cases they also manipulate resolution or other parameters of the imagery data to match the display characteristics. However, this is very complicated process since each application needs to deal with different type of imagery data, residing on servers running different operating systems, and requiring different application procedural interfaces to access them. In addition, clients may not be powerful enough to manipulate imagery information in real time. Although, they can do simple operations such as changing resolution, as well as simple optimization operations, they may not be capable to run advanced applications such as changing the parallax budget of a three-dimensional video to match display characteristics or user preferences.

Example advantages of the disclosed smart gateway are to provide a unified access and connect servers with clients in a seamless manner. Utilizing this architecture, the applications that run on the clients can be very simple and can be easier ported to different devices that run different operating systems therefore reducing development time for developers. The smart gateway also acts as a translator between clients and servers. It is rather inefficient to have owners of severs to make changes on their complicated systems and websites to enable functionality desired in display clients. In addition, application makers spend a significant amount of time to port their software to different platforms and have it to communicate with different servers.

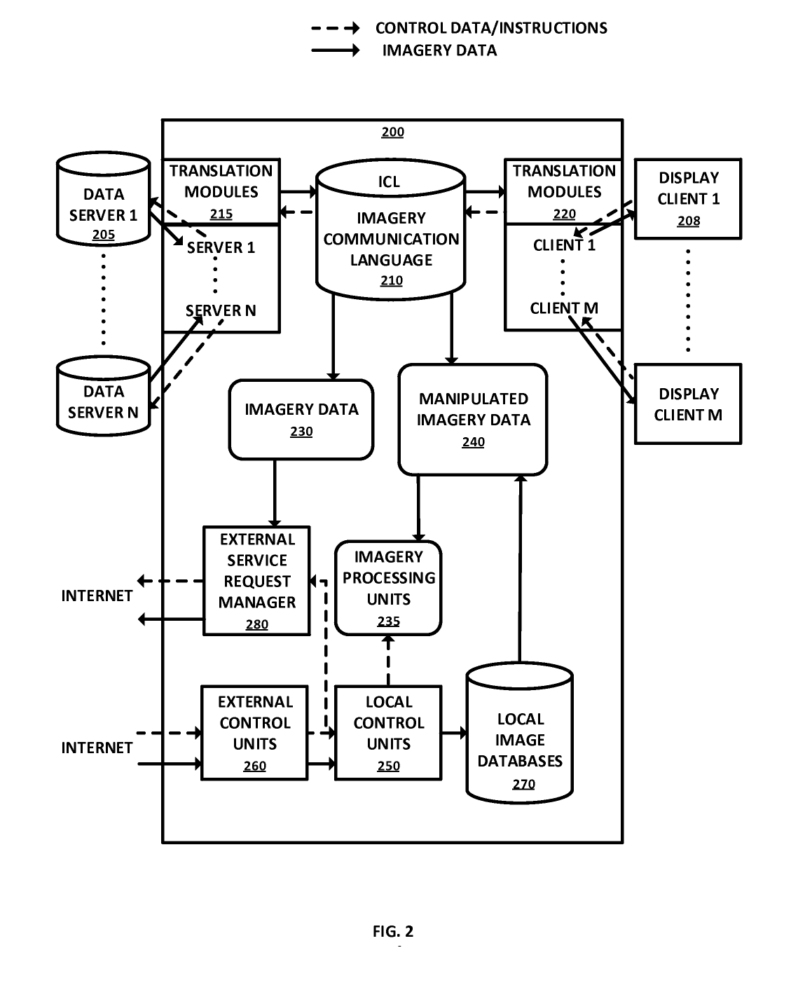

An exemplary implementation of the smart imagery gateway is shown in FIG. 2, which illustrates an example diagram of smart gateway architecture in accordance with embodiments of the present disclosure. It should be noted that the individual components shown in FIG. 2 do not have to be physically located in the same location. The individual components can be implemented using multiple computing units and can be located anywhere in the cloud. The smart gateway 200 receives requests (dashed lines in FIG. 2) from applications running on display clients 208 which pass through their respective translation modules 220. Each display client 208 can have its own translation module 220. Similarly, data servers 205 respond to requests and send imagery data (solid lines in FIG. 2) from their corresponding translation modules 215. The translation modules for both servers 215, and clients 208, can communicate using an imagery communication language (ICL). ICL can be a language by itself, or it can be built in top of popular programming languages and frameworks such as, but not limited to, Java, JavaScript, PHP, HTML and any variants, C and any variants, Linux, Android, iOS, and the like. It provides an abstraction layer so all software modules inside the smart gateway can communicate efficiently with as few changes as possible. The translation modules can take care of the specific architectural concepts of the servers and clients, and there are the only pieces that need to be modified if there are changes on the servers or clients. In addition, if a new client or server is added to the system, only a new translation module that is corresponding to the new client or server needs to be added.

Once a request from a client is translated and sent to the server, the server can respond with the appropriate information, as well as additional control information that may be associated with imagery data such as data ownership, permissions, type, and the like. The received imagery information 230 can potentially pass through the image processing units 235 to change at least one of its parameters or attributes to match the characteristics of the display device. The resulting data of such image processing operation 240 are then sent to the applications running at the display clients.

This entire operation is controlled by the main control unit 250 that resides on the smart gateway. In addition, an interface can be provided to third-party entities to create and run customized applications. Owners of the display clients or the servers can implement and run such customized applications or utilize applications developed by third parties. This implemented using an external control unit 260 that can be connected to the Internet. Examples of authorized entities can include entities that own the imagery data in one of the servers and they wish to provide additional functionality and capabilities to their data without having to change the structure of their servers. This methodology provides a back end channel for enhancing end-user imager data experience. Examples of this may include the inclusion of music during an image slideshow, advertising, as well as any other service or augmentation of the information supplied. Entities that can enhance content may include owners of the data servers, owners of the supplied content, or even consumers with their personal imagery data. This latter case, allows end users to enhance their own experience. The additional information required to provide such functionality may be included in a local imagery database 270. Entities that have the permission to add new functionality can upload such content and/or applications through the Internet. Further, this information which is not limited to only imagery data, can be combined or multiplexed in time or spatial domains and supplied to the display clients.

The local database 270 can also be used to keep other types of information such as content sharing among users having accounts in different websites. Although sharing of photos can be easily enabled using existing photo sharing websites, there are no provisions today to share photos and albums among users that have their data in different sites. Currently, users that want to share content need to sign up, register, login, and transfer their data on the same site photo-sharing website. Systems and methods disclosed herein can enable sharing of content between users even when they have their data on different servers. This can be accomplished by sending a group creation request to the local control unit 250 with the name of the users that can have access to the data along with the general group permissions. Each of the users in the shared group then makes a request to the control unit 250 to access the shared data. In addition, other users can also share their data by again indicating the server, permissions, and folder of the data to be shared. All this sharing information can be stored in the local databases 270. To share imagery data, an application interrogates the local control unit 250 which makes sure that requesting user has the proper permissions to access the data. Once this is confirmed a request is sent to the corresponding server, and data is forwarded to the requesting application.

In accordance with embodiments, a smart gateway can provide additional services to users with display clients by communicating with other external sites to request, provide, and process such services. An example can be a printing request of a photo. Under this scenario, a user that has access to a display client can request a slideshow of photos in one of the available servers. During slideshow, the application running on the client provides a user interface that allows the user to order an album or a photo for printing. The request is forwarded to the control unit 250 of the gateway which communicates with the external service request manager 290 to send the photo to a printing service. The image data from the printer service can come from either the original or modified data after they pass through the image processing unit of the smart gateway.

Other parties can also offer advanced services through the gateway. Advanced services can be implemented by developing scripts using the imaging communication language 210, and by downloading them to the gateway through the external service request manager 280.

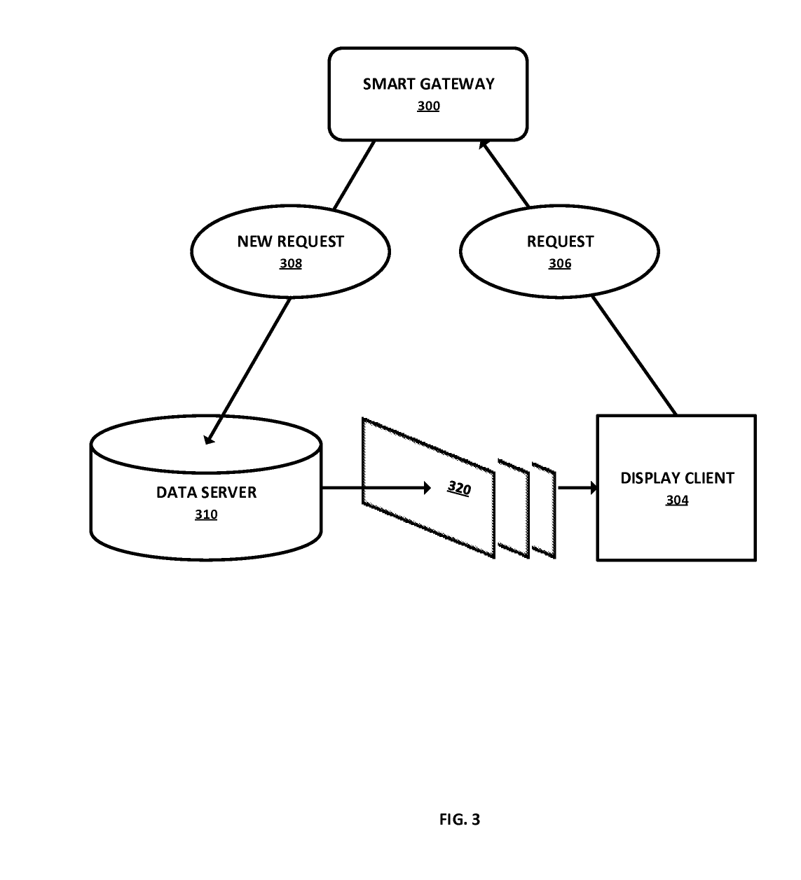

FIG. 3 is an exemplary block level diagram of a simplified communication between a client and a server in accordance with embodiments of the present disclosure. More particularly, FIG. 3 shows a simplified communication mechanism between clients and servers that minimize communication overhead by passing imagery data directly from the servers to the clients. Referring to FIG. 3, an application residing on the display device 304 makes a request 306 that is transmitted to the smart gateway 300. The smart gateway translates the request to something that the data server 310 understands and sends it over. The data server responds by sending directly the imagery data 320 the display client 304. Under this implementation scenario, imagery data do not have to go from the server to the gateway and then to the client thus saving communication bandwidth to the gateway which results in lower cost implementation of the service. It should be noted that in this case, any manipulation of date need to happen on the application running on the display client.

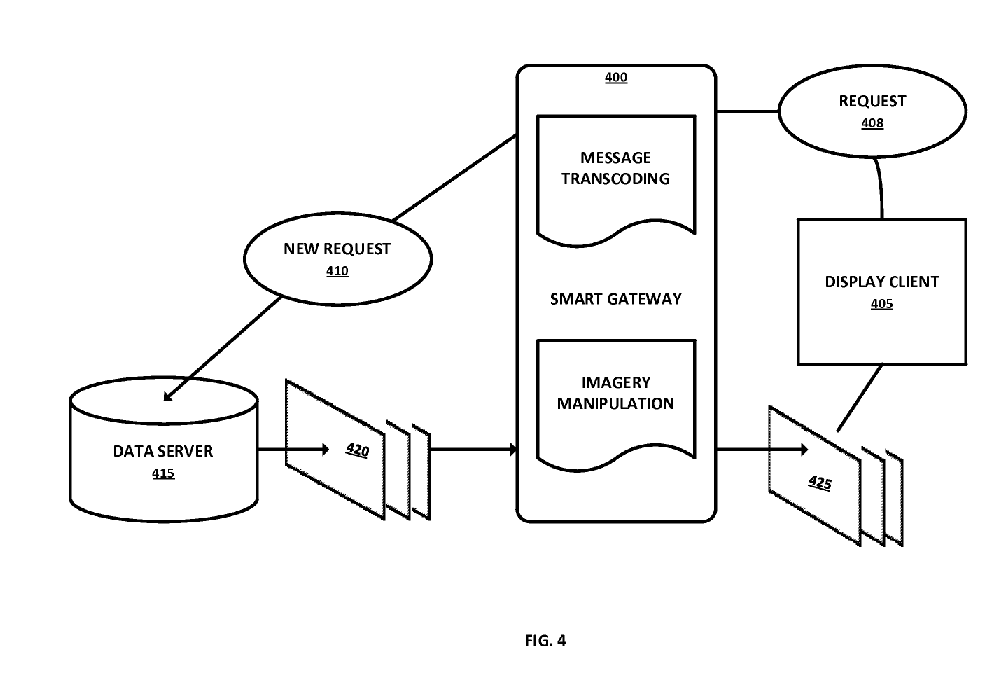

A more sophisticated implementation, shown in FIG. 4, illustrates an exemplary block level diagram of an advanced communication between a client and a server in accordance with embodiments of the present disclosure. In this case, imagery data go through the smart gateway. In this example, the display client 405 sends a request 408 to gateway 400, which is then translated to a request 410, that sever 415 understands. The server 415 responds by sending imagery data 420 to the gateway which then manipulates the data to create a new set of imagery date 425 which match the display characteristics of the client. The manipulated imagery data 425 can then be passed to the display client 405.

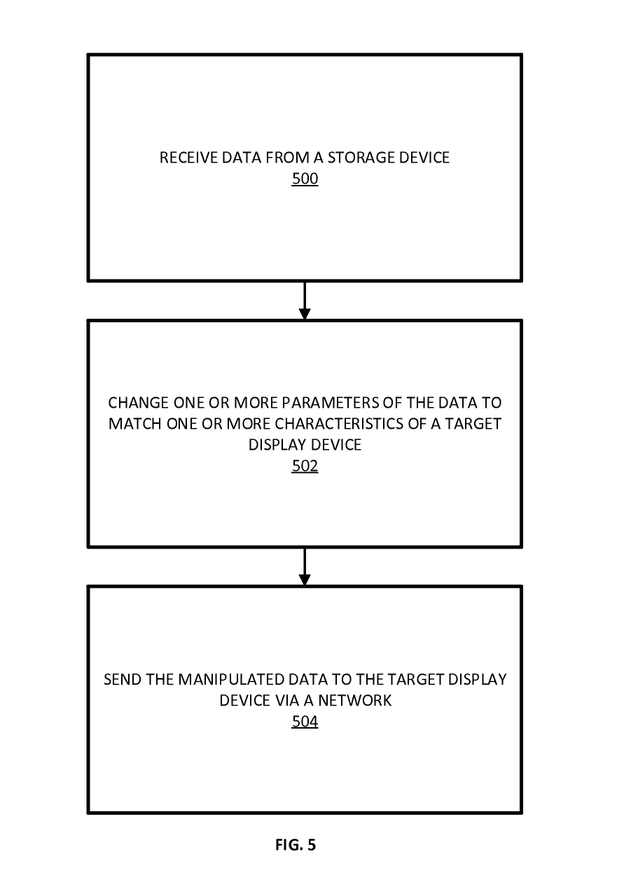

FIG. 5 illustrates a flowchart of an example method for managing data communications with a target display device in accordance with embodiment of the present disclosure. The method may be implemented, for example, by one of the smart gateways 100 shown in FIG. 1. Referring to FIG. 5, the method may include receiving data from a storage device (step 500). For example, the smart gateway 100 may receive data from either of the social networking websites 115, the video sharing websites 110, or the photo sharing websites 105.

The method of FIG. 5 includes changing one or more parameters of the data to match one or more characteristics of a target display device (step 502). As an example, the data may be three-dimensional content or any other suitable data as described in examples herein. For example, depth parameters of the three-dimensional content may be adjusted based on the at least one characteristic of the target display device. In another example, the depth parameters may be adjusted based on preferences of a viewer, a distance of the viewer from the target display device, the like, or combinations thereof. In an example, the target display device may be an auto-stereoscopic display, and multiple synthetic views for the displaying data on the display may be created.

The method of FIG. 5 includes sending the manipulated data to the target display device via a network (step 504). In an example, the network may be the Internet or any other suitable network. The data may then be suitably processed at the target display device, such as one of the smartphones 120 shown in FIG. 1.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
using at least a processor and memory for:
receiving data from a storage device;
changing at least one parameter of the data to match at least one characteristics of a target display device; and
sending the manipulated data to the target display device via a network.

2. The method of claim 1, wherein the network is the Internet.

3. The method of claim 1, wherein the data is three-dimensional content, and
wherein changing at least one parameter of the data comprises adjusting depth parameters of the three-dimensional content based on the at least one characteristic of the target display device.

4. The method of claim 1, wherein adjusting depth parameters comprises adjusting depth parameters of the three-dimensional content based on one of preferences of a viewer and a distance of the viewer from the target display device.

5. The method of claim 1, wherein the target display device is an auto-stereoscopic display, and
wherein the method further comprises creating multiple synthetic views for displaying data on the auto-stereoscopic display.

6. The method of claim 1, further comprising adding supplemental information to the sent data for augmentation purposes.

7. The method of claim 1, further comprising receiving services from one or more other external entities.

8. The method of claim 1, further comprising:
receiving requests from a client;
translating the received requests;
passing the translated requests to a server in a form that the server understands; and
receiving, at the client, a reply from server.

9. The method of claim 1, further comprising providing an open interface for development of custom applications.

10. The method of claim 1, further comprising of one of a storage module and a processing module to facilitate data sharing among different websites

11. The method of claim 1, further comprising of the smart gateway proving only a translation function to facilitate a direct connection between the servers and the clients.

12. A system comprising:
at least a processor and memory configured to:
receive data from a storage device;
change at least one parameter of the data to match at least one characteristics of a target display device; and
send the manipulated data to the target display device via a network.

13. The system of claim 12, wherein the network is the Internet.

14. The system of claim 12, wherein the data is three-dimensional content, and
wherein the at least a processor and memory are configured to adjust depth parameters of the three-dimensional content based on the at least one characteristic of the target display device.

15. The system of claim 12, wherein the at least a processor and memory are configured to adjust depth parameters of the three-dimensional content based on one of preferences of a viewer and a distance of the viewer from the target display device.

16. The system of claim 12, wherein the target display device is an auto-stereoscopic display, and
wherein the at least a processor and memory are configured to create multiple synthetic views for displaying data on the auto-stereoscopic display.

17. The system of claim 12, wherein the at least a processor and memory are configured to add supplemental information to the sent data for augmentation purposes.

18. The system of claim 12, wherein the at least a processor and memory are configured to receive services from one or more other external entities.

19. A computer program product comprising:
a computer readable storage medium having computer readable program code embodied therewith, the computer readable program code comprising:
computer readable code configured to receiving data from a storage device;
changing at least one parameter of the data to match at least one characteristics of a target display device; and
sending the manipulated data to the target display device via a network.

20. The computer program product of claim 19, wherein the data is three-dimensional content, and
wherein the computer readable program code further comprises computer readable code configured to adjust depth parameters of the three-dimensional content based on the at least one characteristic of the target display device.
